(19) United States
(12) Patent Application Publication
(10) Pub. No.: US 2025/0316693 A1
(43) Pub. Date: Oct. 9, 2025

(54) METHOD FOR PREPARING COATING LIQUID INCLUDING CARBON-BASED NANOCOMPOSITE FOR NEGATIVE ELECTRODE OF SECONDARY BATTERY

(71) Applicant: Hong Ki KIM, Gyeongsangbuk-do (KR)

(72) Inventors: Young Sil LEE, Gumi-si, Gyeongsangbuk-do (KR); Hong Ki KIM, Gyeongsangbuk-do (KR); Hyeong Koo KIM, Gumi-si, Gyeongsangbuk-do (KR)

(73) Assignee: Hong Ki KIM, Gyeongsangbuk-do (KR)

(21) Appl. No.: 18/806,653

(22) Filed: Aug. 15, 2024

(30) Foreign Application Priority Data
Apr. 5, 2024 (KR) 10-2024-0017188

(51) Int. Cl. H01M 4/583; H01M 4/02; H01M 4/62; H01M 10/0525

(52) U.S. Cl. CPC H01M 4/583; H01M 4/625; H01M 4/626; H01M 10/0525; H01M 2004/021; H01M 2004/027

(57) ABSTRACT

A method for preparing a coating liquid for a negative electrode of a secondary battery includes a) preparing a carbon-based nanocomposite, b) preparing a composite dispersion including a carbon nanotube and a conductive additive, and c) mixing the carbon-based nanocomposite in the composite dispersion to prepare a composite coating liquid.

### CROSS-REFERENCE TO RELATED APPLICATION

This application claims priority to Korean Patent Applications No. 10-2024-0017188, filed in the Korean Intellectual Property Office on Apr. 5, 2024, the entire contents of which are hereby incorporated by reference.

### BACKGROUND

### Technical Field

The disclosure relates to a method for preparing a coating liquid including a carbon-based nanocomposite for a negative electrode of a secondary battery.

### Description of Related Art

Recently, artificial graphite has been widely used instead of natural graphite as a negative electrode active material for the lithium-ion batteries because it can further improve structural stability, but artificial graphite has a disadvantage of being more expensive than the natural graphite. Graphite is expected to be used as the negative electrode active material at least for the short term, but researches on new negative electrode active materials are being actively conducted to overcome limitation, because once the graphite is close to the theoretical storage capacity of 372 mAh/g, it reaches the limit where it cannot further increase the charging capacity of the battery. As mentioned above, since the performance limit of the lithium-ion battery is heavily dependent on the limit of the negative electrode active material, it is now important to understand that the inherent properties of the material itself and its shape when formed on the electrode greatly affect the capacity and performance of the battery. One attempt to increase the storage capacity of lithium involves replacing graphite with silicon as the negative electrode active material. This attempt has received a lot of attention because while the existing graphite has LiC6 structure in which one lithium atom binds with six carbon atoms, silicon has a Li22Si5 structure at 415° C. in which up to 22 lithium atoms bind with five silicon atoms, thus providing a theoretical storage capacity of 4,200 mAh/g, which is nearly 11 times the capacity of graphite. However, there is a serious problem in that lithium insertion causes swelling of silicon by up to 310% compared to its initial state. This causes the battery to swell and disrupts the separator, leading to concerns about battery safety. Of course, silicon forms a Li15Si4 structure in which 15 lithium atoms bind with four silicon atoms at room temperature, so swelling is slightly reduced compared to high temperature. However, swelling by 280% still occurs.

Further, as lithium escapes, silicon shrinks and cracks, leading to a rapid decrease in storage capacity. To address this issue, various solutions have been proposed and studied, such as using silicon oxides, coating silicon with carbon, etc. However, the issue of reduced energy density of silicon is yet to be resolved.

### SUMMARY

In order to solve one or more problems (e.g., the problems described above and/or other problems not explicitly described herein), the present disclosure provides a coating liquid including a carbon-based nanocomposite for a negative electrode of a secondary battery and a method for preparing the coating liquid, which use a composite coating liquid encapsulated with carbon-based nanocomposite to expand the capacity and increase the energy density of the secondary battery.

According to an example, a coating liquid including a carbon-based nanocomposite for a negative electrode of a secondary battery may be prepared by steps including: a) preparing a carbon-based nanocomposite; b) preparing a composite dispersion including a carbon nanotube and a conductive additive; and c) mixing the carbon-based nanocomposite in the composite dispersion to prepare a composite coating liquid.

The step a) may include steps of: a-1) preparing silicon nanoparticles; a-2) adding a surface treatment agent to a carbon-based nanomaterial to prepare a surface-treated carbon nanostructure; and a-3) adding the surface-treated carbon nanostructure and a binder to the silicon nanoparticle and then milling the mixture.

The step a-3) includes further adding conductive metal-expanded graphite composite particles and then milling the mixture.

The silicon nanoparticles in the step a-1) may have a particle size ranging from 0.1 to 150 nm.

The carbon nanotube is at least one selected from of single-walled carbon nanotube (SWNT), double-walled carbon nanotube (DWNT), thin multi-walled carbon nanotube, and multi-walled carbon nanotube (MWNT).

The conductive additive includes one kind selected from the group consisting of polyacrylic acid, polyacrylate, polymethacrylic acid, polymethylmethacrylate, polyacrylamide, polyvinyl acetate, polymaleic acid, polyethylene glycol, and polyimide.

The conductive metal is aluminum.

The disclosure may provide a coating liquid prepared by any one of the methods described above.

According to some examples of the disclosure, by coating a material to be coated with a composite coating liquid encapsulated with a carbon-based nanocomposite when manufacturing a negative electrode, it is possible to achieve the effect of expanding the capacity and increasing the energy density of the secondary battery.

### BRIEF DESCRIPTION OF THE DRAWING

The above and other objects, features and advantages of the present disclosure will become more apparent to those of ordinary skill in the art by describing in detail exemplary embodiments thereof with reference to the accompanying drawing, in which:

FIG. 1 is a schematic view of a method for preparing a coating liquid for a negative electrode of a secondary battery according to an example of the disclosure.

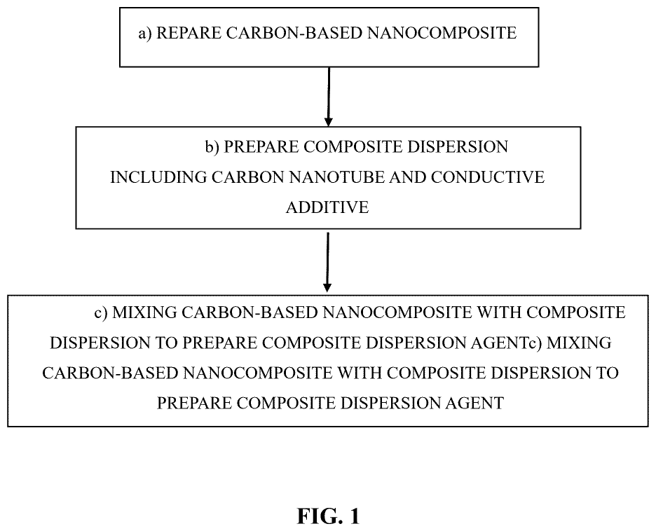

### DETAILED DESCRIPTION

Certain examples of the disclosure will be described in more detail with reference to the drawing. However, this is not intended to limit the disclosure to any particular example, and it is to be understood that all modifications, equivalents, and substitutes that fall within the scope of the spirit and technology of the disclosure are included. When it is determined that a specific description of the widely known technology may obscure the gist of the disclosure, a detailed description thereof will be omitted.

According to some aspects, a coating liquid for a negative electrode of a secondary battery may be prepared by steps including: a) preparing a carbon-based nanocomposite; b) preparing a composite dispersion including a carbon nanotube and a conductive additive; and c) mixing the carbon-based nanocomposite in the composite dispersion to prepare a composite coating liquid.

The effect of increasing the capacity and energy density of the secondary battery is achieved by performing steps a) through c).

Step a) includes: a-1) preparing silicon nanoparticles; a-2) adding a surface treatment agent to a carbon-based nanomaterial to prepare a surface-treated carbon nanostructure; and a-3) adding the surface-treated carbon nanostructure and an additive to the silicon nanoparticle and then milling the mixture.

First, the silicon nanoparticles in step a-1) are prepared through a ball-milling grinding process, and the purpose of this process is to minimize the volume expansion caused by lithium-ion penetration into silicon.

At this time, the silicon nanoparticles in step a-1) have a particle size ranging from 0.1 to 150 nm.

The particle size of the silicon nanoparticles may range from 0.1 to 150 nm, preferably from 0.5 to 120 nm, more preferably from 0.8 to 100 nm, and most preferably from 1 to 90 nm. At this time, if the particle size of the silicon nanoparticles is less than 0.1 nm, the particle size is excessively small and the charge and discharge efficiency can be reduced. Conversely, if the particle size exceeds 150 nm, during a secondary battery charge, a large amount of lithium-ions are inserted into one particle, leading to increased volume expansion, and during the battery discharge, a large amount of lithium-ions escapes, creating vacancies and causing cracking. In addition, as the charge and discharge repeat, lithium-ions may be broken, forming a solid electrolyte interphase (SEI) layer, and as a result, electromigration may not occur, leading to a rapid decline in the capacity of the lithium-ion battery. In other words, electrode stability may deteriorate rapidly.

On the other hand, in step a-2) of adding the surface treatment agent to the carbon-based nanomaterial to prepare the surface-treated carbon nanostructure, the carbon nanotube may be surface-modified by the surface treatment agent so that a functional group such as a hydroxyl group (—OH), a carboxyl group (—COOH), or a combination thereof may be present on the surface of the carbon nanotube.

At this time, in step a-2), the surface treatment agent may include one or more of sulfur acid, nitric acid, phosphoric acid, hydrochloric acid, and hydrogen peroxide, and most preferably, may include a mixed solution of sulfuric acid and nitric acid. In addition, the process may involve sonication and stirring to increase the dispersibility of the carbon nanotube.

At this time, the stirring may be performed at a speed of 1,000 rpm or less to disperse the hydrophilized carbon fibers uniformly.

The stirring speed may be 1,000 rpm or less, 800 rpm or less, or 700 rpm or less.

Meanwhile, by step a-3) of adding the surface-treated carbon nanostructure and the binder to the silicon nanoparticles and then milling the mixture, a carbon-based nanocomposite is formed. Because the carbon nanostructures surface-treated in step a-2) are uniformly distributed on the silicon particle surface by the binder, an excellent electron conduction network can be formed between the silicon particles and the collector, thereby providing an effect of contributing to the improvement of the output characteristic, life characteristics, etc. of the battery.

The binder may be selected from the group consisting of epoxy resin, styrene-butadiene rubber, acrylated styrene-butadiene rubber, acrylonitrile-butadiene rubber, acrylic rubber, butyl rubber, ethylene-propylene copolymer, polyepichlorohydrin, polyphosphazene, polyacrylonitrile, polytetraflene, fluorinated polyvinylidene, polyvinylpyridine, chlorosulfonated polyethylene, nafion, polyester resin, acrylic resin, phenolic resin, polyvinyl alcohol resin, acrylate-based resin, polyaniline, polytiophene, polyacetylene, polypyrrole, and PEDOT, and the epoxy resin may be most preferable.

In other words, the carbon-based nanocomposite formed in steps a-1) to a-3) has a shape in which the carbon nanotube (carbon nanostructure) wraps around the silicon particle.

In addition, for the carbon-based nanocomposite, it is possible to pursue all of the ionic conductivity, electron conductivity, and stability at the same time, and the electrochemical device with the carbon-based nanocomposite applied to the negative electrode may secure excellent charge capacity and superior charge-discharge performance.

Meanwhile, in step b) of preparing the composite dispersion including the carbon nanotube and the conductive additive, the carbon nanotube is at least one selected from single-walled carbon nanotube (SWNT), double-walled carbon nanotube (DWNT), thin multi-walled carbon nanotube, and multi-walled carbon nanotube (MWNT). More preferably, the single-walled carbon nanotube (SWNT) may be used in order to form a more robust carbon nanotube layer on the surface of silicon particles so that the carbon nanotube layer is not easily dislodged by the shrinkage and expansion of the silicon when the battery is driven. More preferably, the weight ratio between the carbon-based nanocomposite and the carbon nanotube preferably ranges from 0.1:10 to 5:10 for the capacity expansion and increased energy density as aimed at by the disclosure. At this ratio, there is the effect of improving dispersibility and electrical conductivity.

The dispersion particle size of the single-walled carbon nanotube is not particularly limited but is preferably between 1 and 15 μm. This is because if the dispersion particle size of the single-walled carbon nanotube is less than 1 μm, it is difficult to uniformly coat the whole surface of silicon particle or carbon-based nanocomposite, resulting in excessively increased contact resistance, and if the dispersion particle size exceeds 15 μm, the dispersion stability of the composite coating liquid deteriorates, resulting in decreased reproducibility of resistance during coating. In particular, in order to significantly reduce the powder resistivity, it is more preferable that the dispersion particle size of the single-walled carbon nanotube is 3 to 10 μm.

The conductive additive includes one kind selected from the group consisting of polyacrylic acid, polyacrylate, polymethacrylic acid, polymethylmethacrylate, polyacrylamide, polyvinyl acetate, polymaleic acid, polyethylene glycol, and polyimide.

The content of the conductive additive is not particularly limited, but is preferably no more than 10 wt % of the total weight of the composite coating liquid, and more preferably 0.1 to 5 wt % in order to minimize the increase in electrode resistance.

Step a-3) includes further adding conductive metal-expanded graphite composite particles and then milling the mixture.

The conductive metal is aluminum.

More specifically, the conductive metal-expanded graphite composite, the carbon nanostructure, has a form in which ultra-thin expanded graphite nanoplatelet obtained by expanding the graphite is intercalated into aluminum particles, and it not only provides a high aspect ratio and large surface area, but also exhibits good dispersibility and excellent mechanical properties, which are advantageous for increasing the charge capacity of the secondary batteries.

With the carbon nanostructure uniformly distributed on the surface of the silicon particle, the conductive metal-expanded graphite composite is distributed under, inside, or on top of the carbon nanostructure film, or at a plurality of positions thereof and may be integrated with the carbon nanostructure. That is, the surface of the silicon particle is heterogeneously doped with the carbon nanostructures and the conductive metal-expanded graphite composite, providing the effect of contributing to improved electrochemical stability and increased charge capacity.

Depending on a method used, the step b) may include further including graphite composite to prepare a composite dispersion.

In this case, the graphite composite corresponds to a composite obtained by mixing a natural graphite, an artificial graphite, and a binder, and then heat treating the mixture. The natural graphite has swelling due to high orientation or inferior rapid charging performance and has relatively many functional groups on the surface compared to the artificial graphite, which negatively affects its high-temperature properties. By mixing the natural graphite, the artificial graphite, and the binder, and then subjecting the mixture to heat treatment, it is possible to obtain a graphite composite from which the functional groups of natural graphite are effectively removed while achieving artificial graphitization of the artificial graphite precursor. By using the resultant graphite composite, it is possible to improve the capacity and lifespan characteristics of the secondary batteries.

The disclosure may provide a coating liquid prepared by any one of the methods described above. The coating liquid may be applied on the surface of a material to be coated and then dried before use.

The coating liquid for the negative electrode of the secondary battery according to an example of the disclosure will be described in more detail below. Note that the scope of the disclosure is not limited by the following examples.

### Example 1

### Preparation of Silicon Nanoparticles

(a-1) 150 nm or less of silicon nanoparticles were prepared by ball milling silicon powder.

### Preparation of Surface-Treated Carbon Nanostructures

(a-2) 1 wt % of carbon nanotubes (MWCNT) were added to a mixed solution of 8M sulfuric acid and nitric acid in a 3:1 volume ratio (75/25, v/v), followed by the ultrasonic treatment process for 20 minutes and then stirring at 80° C. and 600 rpm for 2 hours in an overhead stirrer. After filtration and washing, and then drying in a vacuum oven at 80° C. for 48 hours, the carbon nanostructures were obtained.

### Preparation of Carbon-Based Nanocomposite

(a-3) A carbon-based nanocomposite including silicon particles encapsulated by carbon nanostructures was prepared by adding carbon nanostructures and epoxy resin to silicon nanoparticles and then ball milling the mixture. The silicon nanoparticles, carbon nanostructures, and epoxy resin were mixed in a weight ratio of 10:5:1.

b) A composite dispersion was prepared by mixing 2 wt % of 10 μm single-walled carbon nanotubes, 5 wt % of polyacrylic acid, 10 wt % of graphite, and the remaining amount of water.

c) A composite coating liquid was prepared by mixing the composite dispersion with the carbon-based nanocomposite prepared in step a). The carbon-based nanocomposite was added to an amount of 10 wt % based on the composite dispersion composition.

### Example 2

The preparation was carried out in the same manner as in Example 1, except that composite particles in which expanded graphite is intercalated into the aluminum particles by drying aluminum particles (97 vol %) and expanded graphite nanoplates (3 vol %) at 100° C. and then ball milling the mixture at 400 rpm, were further added in step a-3). The silicon nanoparticles, carbon nanostructures, composite particles, and epoxy resin were mixed in a weight ratio of 10:5:2:1.

### Example 3

The preparation was carried out in the same manner as in Example 2 except that 5 wt % of graphite composite obtained by preparing a mixture of spherical natural graphite, coke, and binder in a weight ratio of 1:1:0.1 and then heat treating the mixture at 200° C. to 300° was added in step b).

### Comparative Example

A coating liquid for a negative electrode of a secondary battery was prepared by mixing 97 wt % of SiOx, 1 wt % of single-walled carbon nanotubes, and 2 wt % of a binder (styrene butadiene rubber) and then stirring the mixture.

### Experiment Example

The coating liquid prepared in Examples 1 to 3 and Comparative Example 1 was coated on a copper current collector to a thickness of 60 μm to prepare a negative electrode thin film. The negative electrode with the final thin film formed thereon was compressed with a heating roll press to control the electrode density to 1.6 g/cc. Lithium secondary batteries respectively employing the negative electrodes prepared as described above were prepared and the characteristics of the lithium secondary batteries were evaluated. Table 1 below shows the characteristics of lithium secondary batteries employing the negative electrode materials of Examples 1 to 3 and Comparative Example 1.

TABLE 1

| | | | | Volume | Capacity |
|---|---|---|---|---|---|
| | | | Capacity | Expan- | Per |
| | Storage | Discharge | Retention | sion | Electrode |
| Unit | Capacity | Capacity | Rate | Rate | Volume |
| (Wt %) | (mAh/g) | (mAh/g) | (%) | (%) | (mAh/cc) |
| Example 1 | 657 | 599 | 91.17199391 | 45 | 888 |
| Example 2 | 669 | 623 | 93.12406577 | 43 | 891 |
| Example 3 | 684 | 648 | 94.73684211 | 39 | 912 |
| Comp. | 545 | 389 | 71.37614678 | 89 | 753 |
| Ex. 1 | | | | | |

As shown in Table 1, it was observed that charge-discharge capacity was higher and the capacity per electrode volume was higher when the carbon-based nanocomposite was used as in Examples 1 to 3 than when non-surface-modified silicon was used.

In addition, it was observed that the charge-discharge capacity characteristics, the capacity retention rate, and the characteristic to significantly lower the volume expansion rate were maintained for a longer period of time when the aluminum-expanded graphite composite was used together than when the carbon-based nanocomposite was used alone.

Although the disclosure has been described by way of certain embodiments, the disclosure is not limited thereto, and various alterations and modifications can be made by those skilled in the art to which the disclosure pertains, within the equivalent scope of the technical ideas of the disclosure and the claims to be described below.

1. A method for preparing a coating liquid for a negative electrode of a secondary battery, the method comprising steps of:
a) preparing a carbon-based nanocomposite;
b) preparing a composite dispersion including a carbon nanotube and a conductive additive; and
c) mixing the carbon-based nanocomposite in the composite dispersion to prepare a composite coating liquid,
wherein the step a) includes steps of:
a-1) preparing silicon nanoparticles;
a-2) adding a surface treatment agent to a carbon-based nanomaterial to prepare a surface-treated carbon nanostructure; and
a-3) adding the surface-treated carbon nanostructure and a binder to the silicon nanoparticle and then milling the mixture.

2. The method according to claim 1, wherein the step a-3) comprises further adding conductive metal-expanded graphite composite particles and then milling the mixture.

3. The method according to claim 1, wherein the silicon nanoparticles in the step a-1) have a particle size ranging from 0.1 to 150 nm.

4. The method according to claim 1, wherein the carbon nanotube is at least one selected from single-walled carbon nanotube (SWNT), double-walled carbon nanotube (DWNT), thin multi-walled carbon nanotube, and multi-walled carbon nanotube (MWNT).

5. The method according to claim 1, wherein the conductive additive includes polyacrylic acid, graphite, and water.

6. The method according to claim 3, wherein the conductive metal is aluminum.

7. A coating liquid prepared by the method according to claim 1.

8. A coating liquid prepared by the method according to claim 3.

9. A coating liquid prepared by the method according to claim 4.

10. A coating liquid prepared by the method according to claim 5.

11. A coating liquid prepared by the method according to claim 6.

12. A coating liquid prepared by the method according to claim 7.
